(19) United States
(12) Patent Application Publication
(10) Pub. No.: US 2006/0237943 A1
(43) Pub. Date: Oct. 26, 2006

(54) Structure of a wheelchair

(76) Inventor: Eric Lai, Chia I City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/109,846

(22) Filed: Apr. 20, 2005

(51) Int. Cl. B62M 1/14

(52) U.S. Cl. 280/250.1; 280/650

(57) ABSTRACT

A wheelchair includes upper and lower frame members, front and rear wheels connected to the lower frame member, and a seat on the upper frame member; the lower frame member has two shock absorbers connected to two ends of a rear portion thereof; the upper frame member has a connecting part on a bottom, which is pivoted to two ends of a front portion of the lower frame member at two ends respectively, and which is connected to one of the shock absorbers at each of two ends of a rear portion thereof; thus, the rider won't be subjected to violent shaking movement when the wheelchair is moving across a rugged ground with many holes.

### BACKGROUND OF THE INVENTION

1. Field of the invention

The present invention relates to a wheelchair, more particularly one, which is equipped with shock absorbers, and which is structured in such a way that it is safer and comfortable to ride on, and the shock absorbers will function more effectively.

2. Brief Description of the Prior Art

Conventional wheelchairs for handicapped persons are not equipped with shock absorbers. Therefore, when the wheelchairs are moving across an uneven ground, violent shaking of the wheelchairs can't be reduced, and the riders will feel very uncomfortable. Moreover, the wheels of the wheelchairs are prone to sink into holes on an uneven ground and become unable to move out, causing a risk of the wheelchairs falling over.

Referring to FIG. 7, an improvement on a wheelchair 4 is provided, which includes a frame 41, a seat 42 held on the frame 41, a back 43, two front wheels 44 connected to two ends of a front portion of the frame 41, two rear wheels 45 connected to two ends of a rear portion of the frame 41, and two shock absorbers 46 respectively connected to the front wheels 44. Thus, violent shaking of the wheelchair will be reduced when the wheelchair is moving across an uneven ground. However, because the shock absorbers 46 are connected to the front wheels 44, the wheelchair has shock-absorbing ability at the front end only, or the wheel axle 47 are connected to the rear wheels 45, the wheelchair has shock-absorbing ability at the rear end only, and the rider still will be subjected to up and down bouncing movement of the wheelchair and feel discomfort. And, when the wheelchair is moving across an uneven ground with many holes thereon, the front wheels 44 are prone to rush into the holes on the ground at a relatively high speed, causing a risk of the rider falling out of the wheelchair and the wheelchair falling over. Therefore, the wheelchair isn't convenient to use.

### SUMMARY OF THE INVENTION

It is a main object of the invention to provide an improvement on a wheelchair to overcome the above-mentioned problem.

The wheelchair of the present invention includes upper and lower frame members, front and rear wheels connected to the lower frame member, and a seat held on the upper frame member. The lower frame member has two shock absorbers connected to two ends of a rear portion thereof. The upper frame member has a connecting part on a bottom, which is pivoted to two ends of a front portion of the lower frame member at two ends respectively, and which is connected to one of the shock absorbers at each of two ends of a rear portion thereof. Thus, the rider of the wheelchair won't be subjected to violent shaking movement, which will cause discomfort, when the wheelchair is moving across a rugged ground.

### BRIEF DESCRIPTION OF THE DRAWINGS

The present invention will be better understood by referring to the accompanying drawings, wherein:

FIG. 1 is a side view of the wheelchair in the present invention,

FIG. 2 is a view of the wheelchair of the invention being in use (1),

FIG. 3 is a view of the wheelchair of the invention being in use (2),

FIG. 4 is a rear view of the wheelchair in the present invention,

FIG. 5 is a fragmentary exploded perspective view of the wheelchair in the present invention,

FIG. 6 is a rear view of wheelchair of the present invention in the folded position, and

FIG. 7 is a side view of the conventional wheelchair.

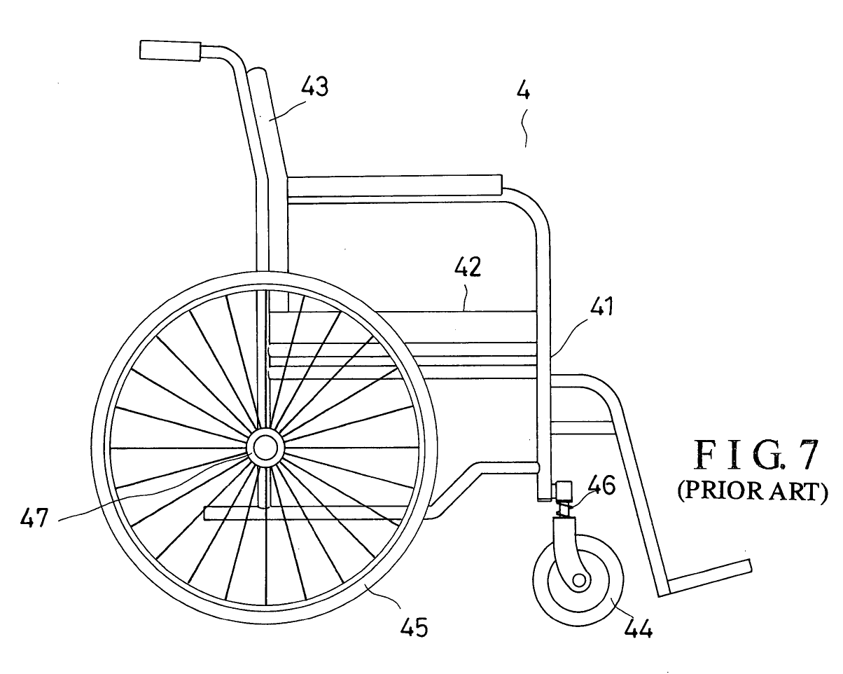

### DETAILED DESCRIPTION OF THE PREFERRED EMBODIMENTS

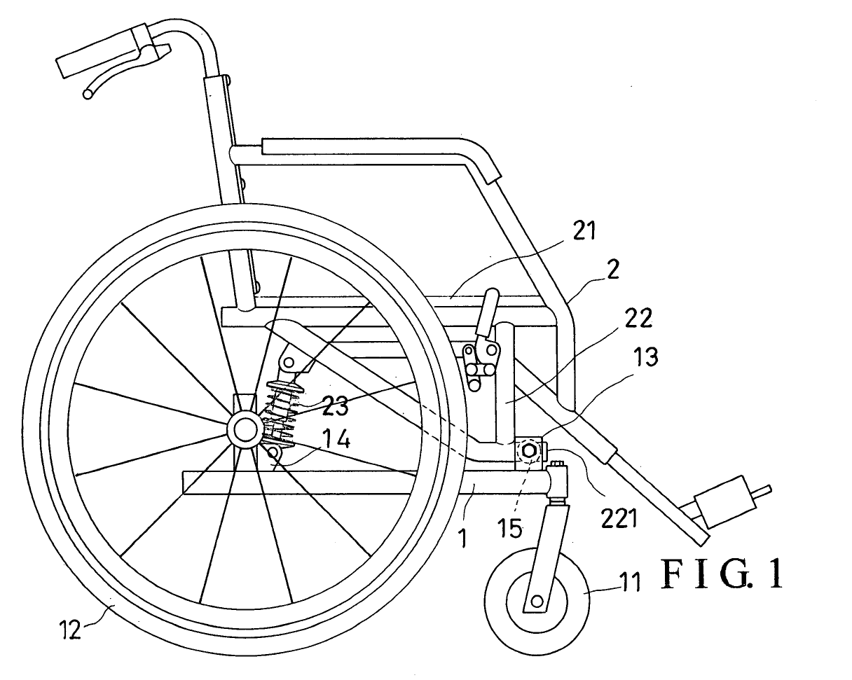

Referring to FIG. 1, a preferred embodiment of a wheelchair includes a lower frame member 1, and an upper frame member 2.

The lower frame member 1 has two front wheels 11 respectively connected to left and right ends of a front portion thereof, and two rear wheels 12 respectively connected to left and right ends of a rear portion thereof. Furthermore, the lower frame member 1 has front protruding portions 13 on the left and the right ends of the front portion, and rear protruding portions 14 on the left and the right ends of the rear portion. Each of the front protruding portions 13 has a bearing 15 fitted therein.

The upper frame member 2 has a seat 21 held thereon, and includes a connecting frame part 22 on a bottom thereof, which has protruding rods 221 at a front portion. The upper frame member 2 is pivoted to the bearings 15 in the front protruding portions 13 of the lower frame member 1 at the protruding rods 221 thereof. And, each of the rear protruding portions 14 of the lower frame member 1 has a shock absorber 23 connected thereto, which shock absorber 23 is connected to a rear end of the connecting frame part 22.

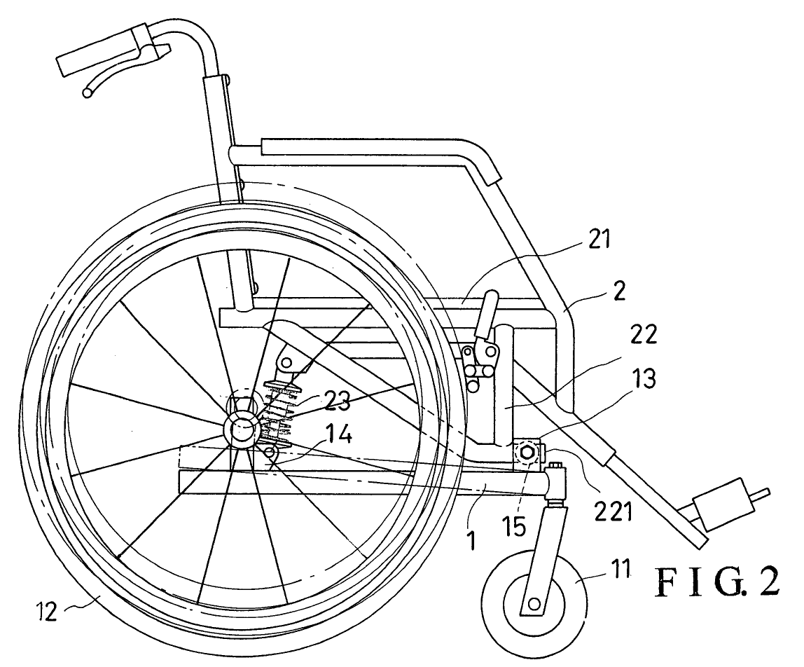

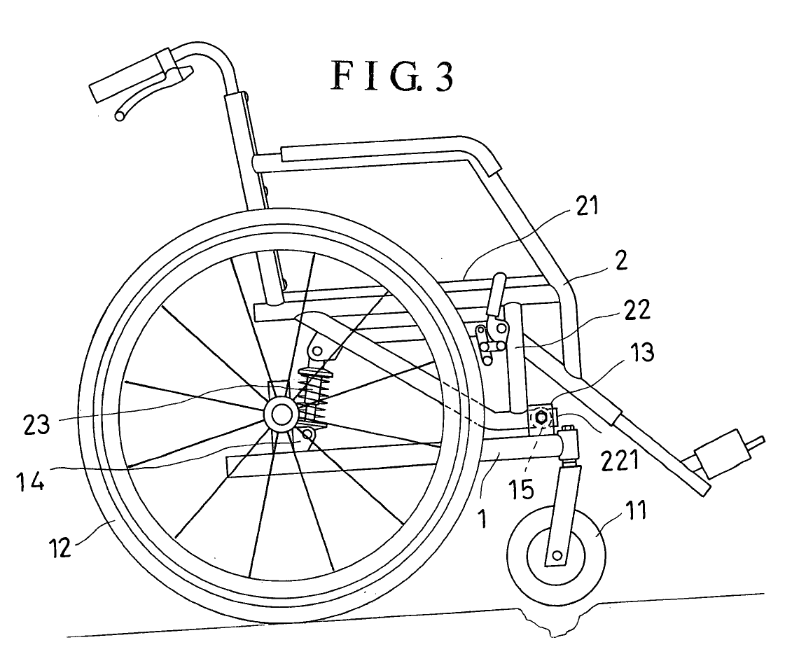

Because the upper frame member 2 is pivoted to the lower frame member 1 with the protruding rods 221 being respectively connected to the bearings 15, and it is connected to the two shock absorbers 23 at the rear end of the connecting frame part 22 thereof, which shock absorbers 23 are connected to the rear protruding portions 14 of the lower frame member 1, the rider on the wheelchair will be protected from violent movement of the wheelchair when the wheelchair is moving along an uneven ground. And referring to FIGS. 2 and 3, if one of the front wheels 11 comes across a small hole on the ground when the wheelchair is moving across an uneven ground, the other ones of the wheels 11 and 12 will help prevent this front wheel 11 from sinking into the small hole, thus preventing the wheelchair from tilting, and discomfort of the rider.

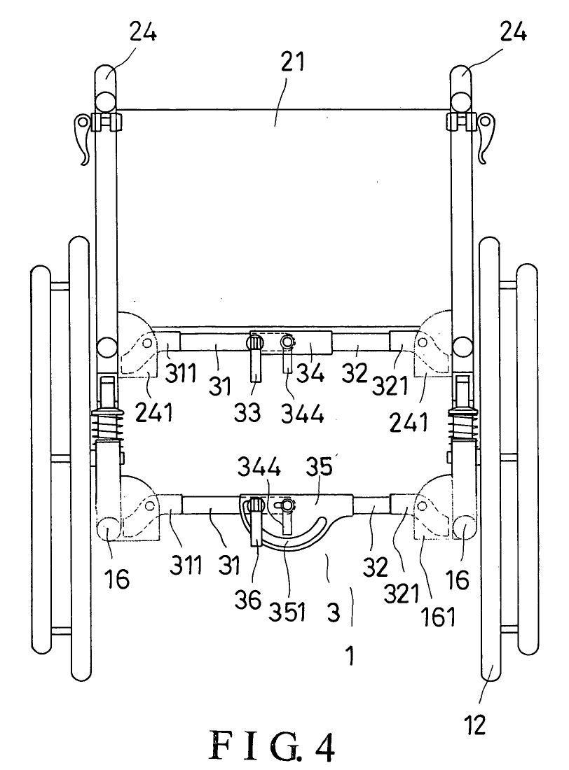

Referring to FIG. 4, the lower frame member 1 includes left and right support parts 16 while the upper frame member 2 includes left and right support parts 24. Each of the left and the right support parts 16 of the lower frame member 1 has front and rear pivotal portions 161 thereon while each of the left and the right support parts 24 of the upper frame member 2 has front and rear pivotal portions 241 thereon.

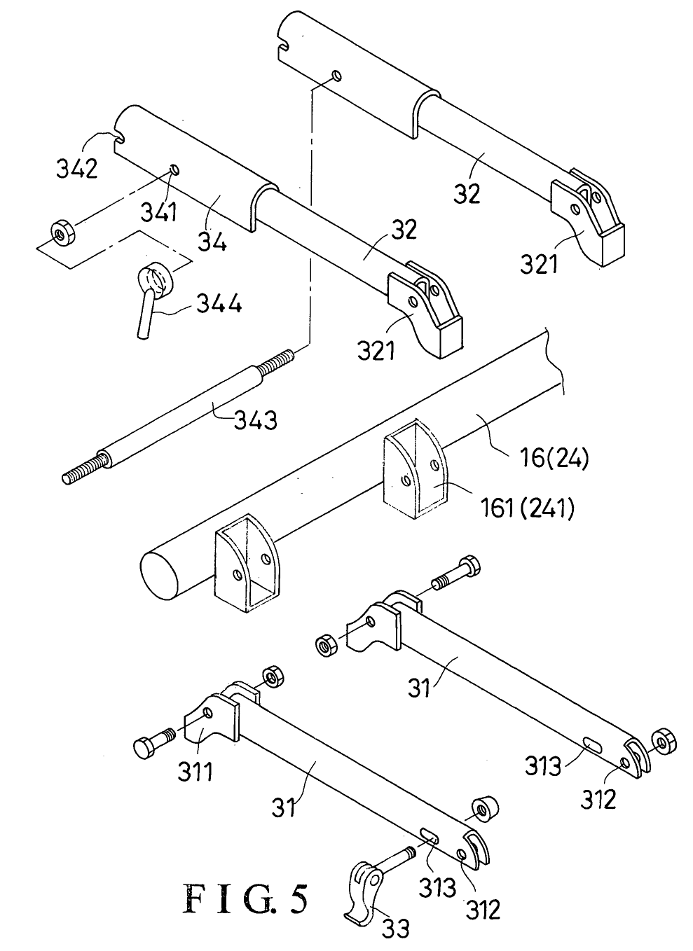

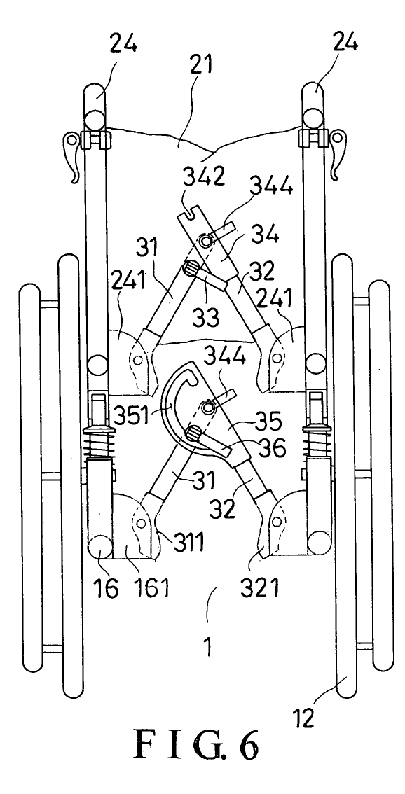

And, the lower frame member 1 has a transverse connecting device 3, which is pivoted to the front pivotal portions 161 of the left and the right support parts 16 at two ends, and the lower frame member 1 has a transverse connecting device 3, which is pivoted to the rear pivotal portions 161 of the left and the right support parts 16 at two ends. Referring to FIG. 5, each of the transverse connecting devices 3 includes first and second connecting rod parts 31, 32, a fastening lever 33, and a connecting unit 34; each first connecting rod part 31 has a connecting block 311 at a first end, a pivotal hole 312 at a second end, and a slot 313 near to the second end; each second connecting rod part 32 has a connecting block 321 at a first end, and is securely joined to a respective connecting unit 34 at a second end; each connecting unit 34 has a pivotal hole 341, and a gap 342; each threaded connecting element 343 has threads on two ends. The first connecting rod parts 31 are pivoted to corresponding ones of the connecting units 34 by means of passing a threaded connecting element 343 through the pivotal holes 312 and 341, which threaded connecting element 343 has threads at two ends. And, the two transverse connecting devices 3 are respectively pivoted to the front and the rear pivotal portions 161 of the lower frame member 1 at the connecting blocks 311, 321. Furthermore, the threaded connecting element 343 has a handle sleeve 344 on a rear end portion. The fastening levers 33 are passed through respective ones of the slots 313; thus, the transverse connecting devices 3 will be held in the stretched position by the fastening levers 33 after the fastening levers 33 are passed into the corresponding gaps 342 to engage the connecting units 34, and pivoted to a fastening position. And referring to FIG. 6, the transverse connecting devices 3 can be folded by means of lifting the handle sleeve 344 on the threaded connecting element 343 upwards after the fastening levers 33 are pivoted to a loosening position, and disengaged from the connecting units 34.

Thus, the wheelchair can be folded to occupy less space when it isn't in use.

Or alternatively, the upper frame member 2 can be equipped with a transverse connecting device 3, which is pivoted to the front pivotal portions 241 of the left and the right support parts 24 at two ends, and a transverse connecting device 3 as well, which is pivoted to the rear pivotal portions 241 of the left and the right support parts 24 at two ends; referring to FIG. 5, each transverse connecting device 3 includes first and second connecting rod parts 31, 32, a fastening lever 33, and a connecting unit 35; each first connecting rod part 31 has a connecting block 311 at a first end, a pivotal hole 312 at a second end, and a slot 313 near to the second end; each second connecting rod part 32 has a connecting block 321 at a first end, and is securely joined to a respective connecting unit 35 at a second end; each connecting unit 35 has a pivotal hole, and a curved trench 351; each threaded connecting element 343 has threads on two ends. The first connecting rod parts 31 are pivoted to corresponding ones of the connecting units 35 by means of passing a threaded connecting element 343 through the pivotal holes 312 of the first connecting rod parts 31 and the pivotal holes of the connecting unit 35. And, the two transverse connecting devices 3 are respectively pivoted to the front and the rear pivotal portions 241 of the upper frame member 2 at the connecting blocks 311, 321 thereof; the threaded connecting element 343 also has a handle sleeve 344 on a rear end portion. The fastening levers 33 are passed through respective ones of the slots 313; thus, the transverse connecting devices 3 will be held in the stretched position by the fastening levers 33 after the fastening levers 33 are passed into an upper end of the curved trench 351 to engage the connecting units 35, and pivoted to a fastening position. And, the transverse connecting devices 3 can be folded by means of lifting the handle sleeve 344 on the threaded connecting element 343 upwards after the fastening levers 33 are pivoted to a loosening position, and disengaged from the connecting units 35; thus, the fastening levers 33 will be moved along, and relocated at the other end portions of the curved trenches 351 of the connecting units 35 as shown in FIG. 6.

From the above description, it can be easily seen that the wheelchair of the present invention has better shock-absorbing capability, and is more comfortable to ride on when compared with the conventional one.

What is claimed is:

1. Structure of a wheelchair,
a lower frame member; the lower frame member having two front wheels respectively connected to two ends of a front portion thereof; the lower frame member having two rear wheels respectively connected to two ends of a rear portion thereof; the lower frame member having protruding portions on two ends of the front portion; the lower frame member having protruding portions on two ends of the rear portion; each of the rear protruding portions having a shock absorber connected thereto; and
an upper frame member; the upper frame member having a seat held thereon; the upper frame member including a connecting frame part on a bottom thereof; the connecting frame part having two protruding rods at a front portion; the upper frame member being pivoted to the front protruding portions of the lower frame member at the protruding rods; the shock absorbers being connected to a rear portion of the connecting frame part.

2. The wheelchair as claimed in claim 1, wherein bearings are provided at joints between the front protruding portions of the lower frame member and the protruding rods of the upper frame member.

3. The wheelchair as claimed in claim 1, wherein each of the upper and the lower frame members includes left and right support parts, and at least one transverse connecting device; the transverse connecting device including first and second connecting rod parts, and a connecting unit securely connected to the second connecting rod part; the first connecting rod part being pivoted to the connecting unit such that the transverse connecting device is foldable at a middle portion; the transverse connecting device being pivoted to the left and the right support parts at two ends thereof; the transverse connecting device having a fastening lever, which will engage the connecting unit so as to prevent the transverse connecting device from folding when it is in a fastening position.

4. The wheelchair as claimed in claim 1, wherein each of the upper and the lower frame members includes left and right support parts, and at least one transverse connecting device; the transverse connecting device including first and second connecting rod parts, and a connecting unit securely connected to the second connecting rod part; the first connecting rod part being pivoted to the connecting unit such that the transverse connecting device is foldable at a middle portion; the transverse connecting device being pivoted to the left and the right support parts at two ends thereof; the transverse connecting device having a fastening lever, which is passed through the curved trench of the connecting unit, and which will engage the connecting unit so as to prevent the transverse connecting device from folding when it is in a fastening position.

5. The wheelchair as claimed in claim 3, wherein each of the upper and the lower frame members has front and rear transverse connecting devices, a threaded connecting element, and a handle sleeve secured on one end of the threaded connecting element, which threaded connecting element is passed through the first connecting rod parts and the connecting units of both the front and the rear transverse connecting devices such that the first connecting rod parts are pivoted to the corresponding connecting units, and such that both the front and the rear transverse connecting devices can be folded together by means of lifting the handle sleeve.
